(19) United States
(12) Patent Application Publication
(10) Pub. No.: US 2015/0028643 A1
(43) Pub. Date: Jan. 29, 2015

(54) Universal Chair Lift Apparatus

(71) Applicant: Cora Marie Reborse, Oklahoma City, OK (US)

(72) Inventor: Cora Marie Reborse, Oklahoma City, OK (US)

(21) Appl. No.: 13/950,846

(22) Filed: Jul. 25, 2013

(51) Int. Cl. A61G 5/14

(52) U.S. Cl. CPC A61G 5/14
USPC 297/344.16; 297/344.12; 297/344.15

(57) ABSTRACT

An adjustable lift apparatus for use with a rocking/reclining chair having at least one support leg, the apparatus comprising an upper support having at least one leg stand to securely engage at least one leg, and an adjustment means for adjusting each leg support stand to the desired location to engage all of the chair's legs; a lift means for reversibly biasing the upper support away from the base; a base adapted to rest on the floor and support the apparatus; a controller in communication with and controlling the lift means, whereby, the adjustable lift apparatus provides an inexpensive and universal way of engaging and raising the rocker/recliner chair with varying styles of legs and bases through the use of a controller to automatically position the chair to a user desired height thereby making it easier for elderly and handicapped persons to get into and out of the chair.

### CROSS-REFERENCE TO RELATED APPLICATIONS

None.

### FIELD OF THE INVENTION

The present invention relates generally to an aide for elderly and handicapped persons. The invention relates to a lifting apparatus for lifting a chair. More particularly, the invention relates to an apparatus that may comprise an upper support, commercially available lifting device and base, allowing an elderly or disabled person to lift a common household chair to a selected height facilitating easy and safe entrance and exit of the chair.

### SUMMARY OF THE INVENTION

The invention relates to a device for lifting a chair. More particularly, the invention relates to a device that allows a common rocker/recliner chair typically found in homes to be raised and lowered to the desired height that is easily accessible to the user. Commonly, the user will likely be an elderly or disabled person and this device enables them to safely enter and exit their chair without the risk of falling as compared to other chair lifts that raise and tilt forward. Specifically, persons with certain infirmities that affect their balance may not have the ability to control their forward movements thereby putting them at risk when they are lifted and thrust forward with other systems.

In general, prior art teaches various devices for raising chairs such as simply adding a chair leg extension on each individual leg to more complicated devices wherein they are fully integrated as part of the chair with the height automatically controlled by an electrical, hydraulic, mechanical or pneumatic device lifting the chair.

The set of patents below generally teach how to semi-permanently raise different types of chairs to selected heights thus making it easier for a child, an elderly person or a handicapped person to more safely and efficiently use the chair. An early patent, U.S. Pat. No. 3,215,382 to Stein, teaches a device for raising a chair to a predetermined height with a box frame and legs that has an adjustable planform to accommodate a conventional dining chair with legs thus converting it for use as a youth chair. U.S. Pat. No. 3,952,983 to Crochet, teaches a device for raising a child's chair using a rigid crossbeam and longitudinally extensible members. The device has a fixed height but the height of the chair can be changed by selecting different models thereby incurring additional cost. U.S. Pat. No. 5,251,960A to Anderson, teaches a device for raising a rocker/recliner by adding side runners with cross members that engages exactly to the frame of the rocker/recliner to be raised. U.S. Pat. No. 5,899,422 to Eke, teaches a device for raising the height of a piece of furniture such as a chair, table, or bed. The adjustable furniture leg extensions are independent of each other so they can adjust to different and non-standard leg spacing. U.S. Pat. No. 6,575,414B2 to Cuzzocrea, teaches a device for raising a bed using a unitary block adapted to fit various styles and heights of bed legs. It provides manual adjustability by changing the holes where the legs are engaged. Additionally, extension blocks are provided to increase the height of the leg further by fitting over the unitary block. U.S. Pat. No. 6,929,328 B1 to Snyder, teaches a device for raising a chair, using two elongated members that sit on each side of the chair parallel to one another. This device requires no power and uses removable pegs to accommodate different chair makes and models and the peg placement is based upon the type of chair legs and/or transverse cross-members. Each of the foregoing patents has the same shortcomings that is addressed by the present invention in that each device requires manual intervention any time the user wants to change the height no matter how small or large by forcing the user to physical lift the chair to make changes.

Another set of patents below differ from the above described patents in that their height is not semi-permanent and this set of patents relate to a means for lifting or lowering a chair to a user selected height without manual intervention. The patents below teach how a user can automatically control the height adjustment of a chair within specific applications. U.S. Pat. No. 7,909,404B2 to Spangler, which teaches a device for pneumatically raising a seat assembly in an operator control station of a machine that operates outdoors in a high vibration environment. The device is specific to each machine and not universally compatible to any chair. U.S. Pat. No. 8,267,474 B2 to Fetisoff, teaches a device for pneumatically raising a seat on a wheeled chair that is used to lift and lower a handicapped person seated in the chair into and out of a vehicle. U.S. Pat. No. 8,403,409 B2 to Polard, teaches a device for a combination lift and reclining chair. This device fully integrates the electro-mechanical lifting mechanism into the reclining chair. The above mentioned patents provide for a means for the user to automatically control the height adjustment without manual intervention unlike the previously described patents, however, each of these patents were tied to a specific application of the device and could not be universally employed to commonly used chairs.

The present invention overcomes these shortcomings in the prior art by providing a means to universally adapt the present device to a rocker/recliner chair with varying styles of legs and bases and providing a means for the user to control automatically the lifting or lowering of the chair to a user determined height using a controller. Additionally, the present device does not tilt the chair forward when raising, thus preventing persons with medical conditions affecting their balance and forward movement control from being thrust forward and injured. This is an inexpensive method to add a lift system to an already existing chair within one's home

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a side view of the left side of the chair attached to the upper support, scissor lift, and base in the operable position (up) according to a preferred embodiment of the present invention.

FIG. 2 is a top view of the chair, upper support, and chair attached to the upper support, according to a preferred embodiment of the present invention.

FIG. 3 is a side view of the left side of the upper support attached to the scissor lift, and base in the operable position (up) according to a preferred embodiment of the present invention.

FIG. 4 is a side view of the left side of the upper support attached to the scissor lift, and base in the collapsed position (down) according to a preferred embodiment of the present invention.

FIG. 5 is a top view of the scissor lift attached to the upper support and base, according to a preferred embodiment of the present invention.

FIG. 6 is a top view of the base, according to a preferred embodiment of the present invention.

FIG. 7 is a front view of the base, according to a preferred embodiment of the present invention.

FIG. 8 is a side view of the left side of the base, according to a preferred embodiment of the present invention.

FIG. 9 is a perspective view of a screw type lift system, according to an alternative embodiment of the present invention.

FIG. 10 is a top view of a screw type lift system, according to an alternative embodiment of the present invention.

### DETAILED DESCRIPTION OF THE INVENTION

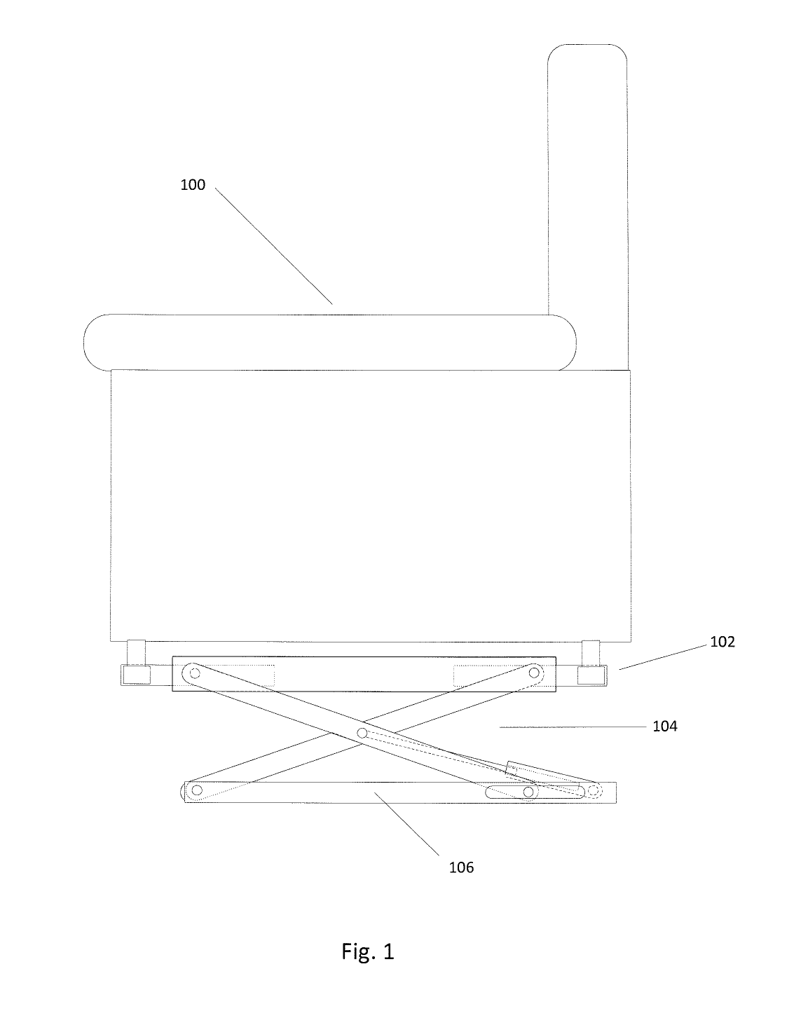

FIG. 1 illustrates a chair lifting apparatus in an operational position. A chair 100 is affixed a top a upper support 102 by a leg engagement means 214 that has been adjusted to fit the chair 100 and will be described later if further detail. The upper support 102 is pivotally affixed to the scissor lift 104. The scissor lift 104 is pivotably and slideably affixed to the base 106.

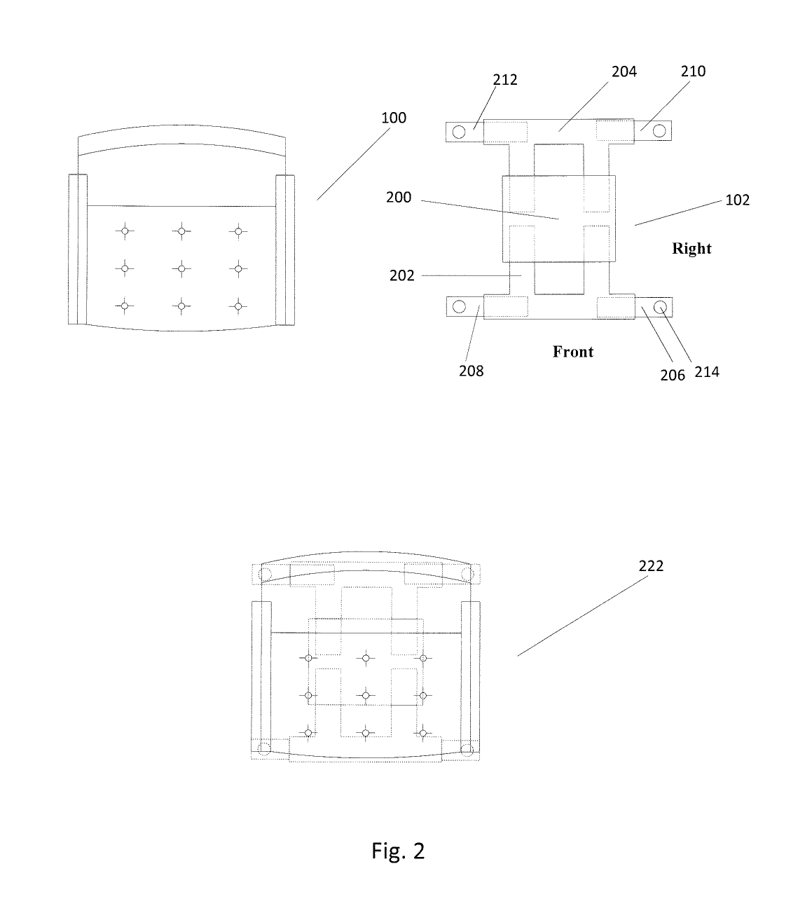

FIG. 2 illustrates a top view of the chair 100, upper support 102, and a composite top view 222 of the chair affixed a top the upper support 102. FIG. 2 further illustrates the upper support 102 with its component parts a body 200, a front longitudinal adjustment 202, a rear longitudinal adjustment 204, front left lateral adjustment 206, front right lateral adjustment 208, rear right lateral adjustment 210, rear left lateral adjustment 212, and leg engagement means 214.

The front longitudinal adjustment 202 and rear longitudinal adjustment 204 are shown received within body 200 and can be extended or retracted therein. This allows the front longitudinal adjustment 202 and rear longitudinal adjustment 204 to match the depth of the chair 100 and be positioned such that the chair 100 is longitudinally centered on the upper support 102.

Each longitudinal adjustment has a pair of lateral adjustments. The front left lateral support 206 and front right lateral support 208 are telescopically affixed to the front longitudinal adjustment 202. The rear left lateral adjustment 210 and the rear right lateral adjustment 212 are telescopically affixed to the rear longitudinal adjustment 204. Each lateral adjustment has a corresponding leg engagement means 214 affixing the chair 100 to the upper support 102. These lateral adjustments allow for the width of the chair 100 to be matched and positioned such that the chair 100 is laterally centered on the upper support 102. By longitudinally and laterally centering the chair 100 on the upper support 102, the chair 100 should be balanced during lifting operation. Additionally, two other features apply to this design; first, if the center of gravity is not in the center of the chair 100 planform then longitudinal and lateral adjustments may be applied to reposition the center of gravity of the chair 100 over the center of the upper support 102 for balance during operation. Secondly, the upper support 102 can be adjusted to different chair planforms by adjusting the longitudinal and lateral adjustments to match the base or legs of the chair 100.

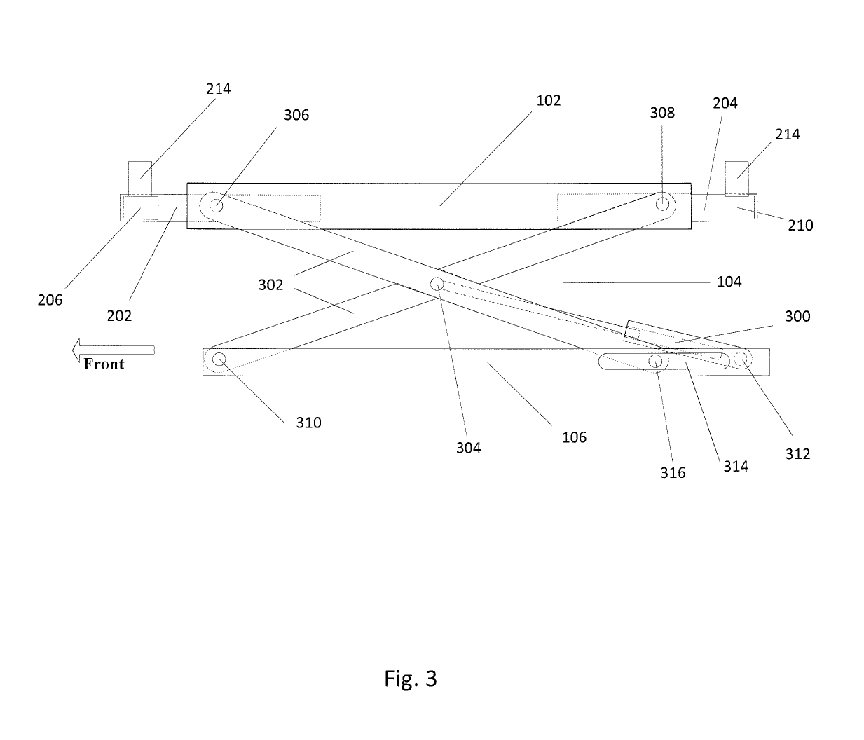

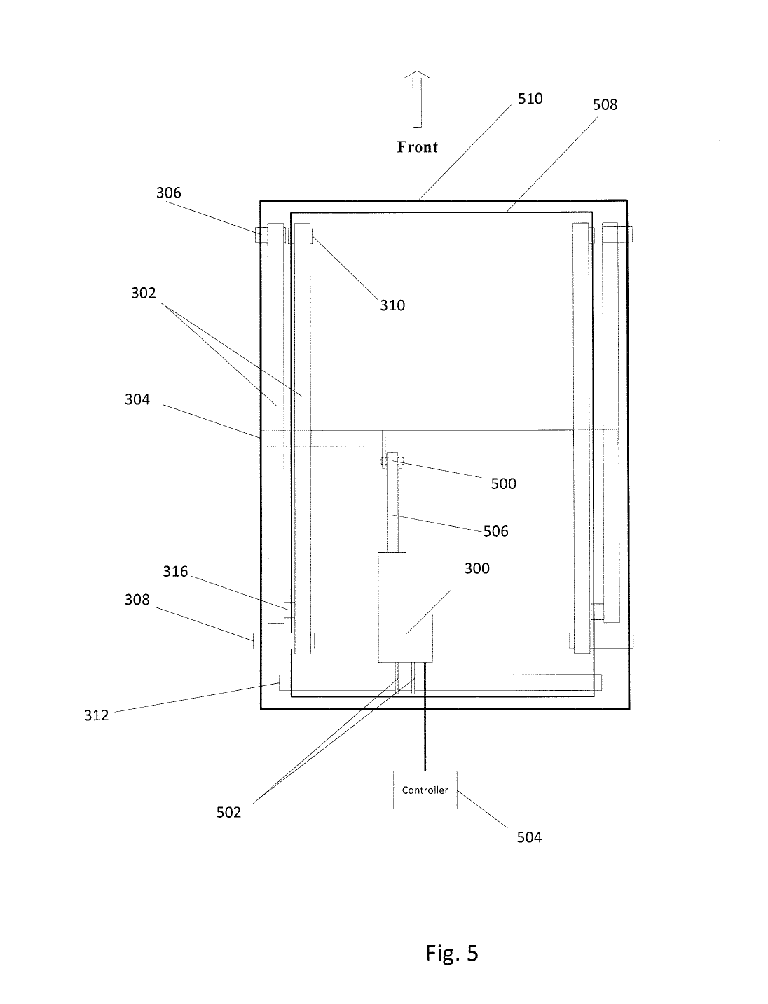

FIG. 3 is a side view of the left side of chair lifting apparatus with its component parts, the upper support 102, a scissor lift 104 and a base 106. The upper support 102 is pivotally affixed to the scissor lift 104 by two pairs of scissor arms 302 with only one pair scissor arms 302 depicted in the current view and the second set of scissor arms 302 later depicted in FIG. 5. One scissor arm 302 is pivotally attached to the upper support 102 at the upper front pivot point 306 and a second scissor arm 302 is pivotally attached to the upper rear pivot point 308.

The scissor arm 302 connected to the upper front pivot point 306 extends rearward and down and scissor arm 302 connected to the upper rear pivot point 308 extends forward and down and both extend toward the base 106. The scissor lift arms 302 are pivotally affixed at a center pivot point 304 where they cross.

The scissor lift 104 is further attached to a base 106. The scissor arm 302 extending forward and down from the rear pivot point 308 is pivotably affixed to the base front pivot point 310. The scissor arm 302 extending backward and down from the front pivot point 306 is slidingly attached to the base 106, wherein a sliding scissor arm pin 316 attached to the scissor arm 302 and rides in a slot 314 in the base 106. A hydraulic lift 300 is pivotally attached to the base 106 by a lift base connection 312. FIG. 5 later illustrates the hydraulic lift 300 attachment to the lift point 500 where the upper support 102 is lifted by hydraulic lift 300 when the hydraulic piston 506 connected to center pivot point 304 is extended. Because two scissor arms 302 are pivotably affixed to the front of the base 106 and only rotate during operation, when the extension begins the scissor arms 302 upward movement lifting the upper support 102 while the rearward facing scissor arms connected to the sliding scissor arm pin 316 slides from the rear of the base 106 in the slot 314 toward the front of the base 106 until the desired position is reached or the upper limit is reached. The reverse process is used to lower the upper support 102. Finally, the scissor arms 302 rotate on the pivot points allowing the upper support 102 to maintain level during either the raising or lowering operation.

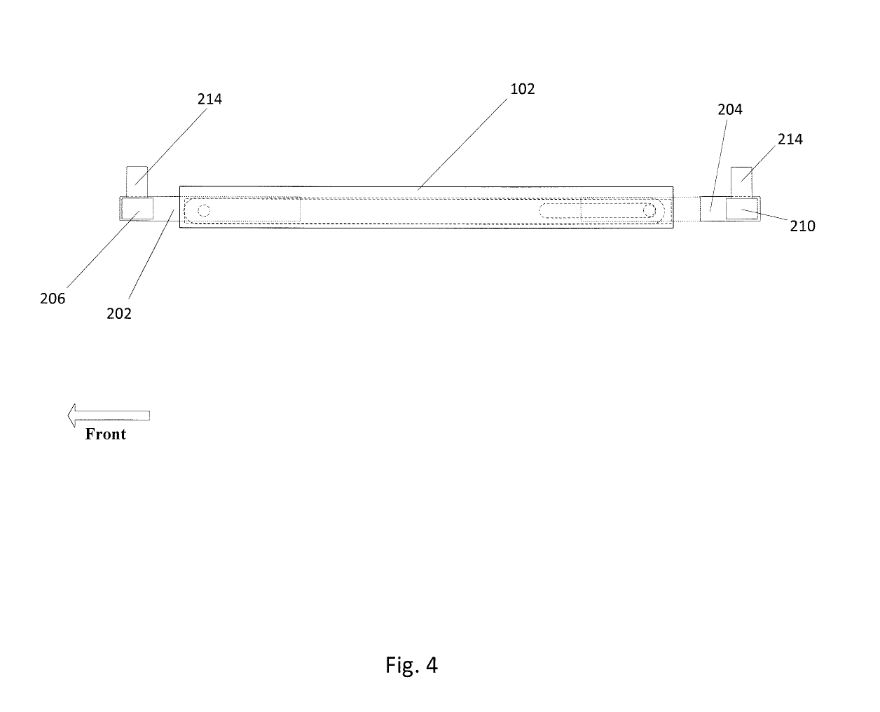

FIG. 4 is a side view of the left side of the chair lifting apparatus in a down or collapsed position. Upon reversing the lifting process described above, the lifting apparatus will come to rest in a down or collapsed position wherein the upper support 102 conceals the scissor lift 104, hydraulic lift 300, and the base 106 providing a minimized profile.

FIG. 5 is a top view of the scissor lift with other component parts of the lifting mechanism represented, the upper support 102 is represented by general chair outline 510 and the base 106 is represented by a general base outline 508. FIG. 5 further depicts the two pairs of scissor arms 302 connected at the center pivot point 304 each pair disposed to each side of the lift.

The hydraulic lift 300 pivotably attaches to the center pivot point 304 at the lifting point 500 where the system controller 504 provides input to the hydraulic lift 300 extending or retracting the hydraulic piston 506 connected to the lift point 500. The hydraulic lift 300 is pivotably affixed to the base 106 by the lift base connection 312 and the hydraulic body connector 502. As described earlier, when the hydraulic piston 506 extends and the upper support 102 begins to lift, the hydraulic body connector 502 rotates on the lift base connection 312 and the lift point 500 rotates on the center pivot point 304 allowing both to change angles based of the height of the lift thus preventing it from binding during the operation

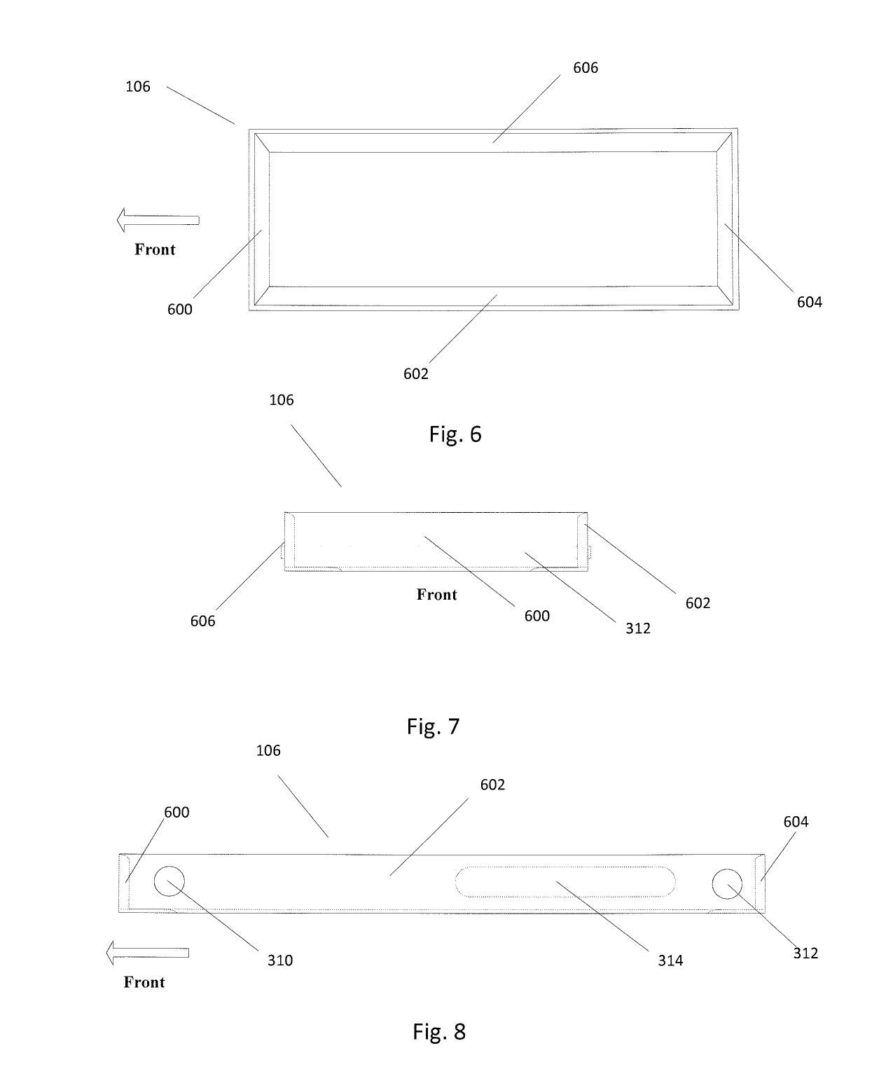

The next three figures depict the base 106 in differing views. FIG. 6 shows a top view of the base 106, FIG. 7 depicts a front view of the base 106, and FIG. 8 depicts the left side view of the base 106. FIG. 6 has four sides, a front 600, left 602, rear 604, and right 606 when assembled create a rectangular base. A person skilled in the art can create this this base by molding or forging the part as a single piece or building it from multiple pieces of angle-iron that are welded at the seams.

FIG. 8 is a side view of the left side of the base. This view further illustrates the base front pivot point 310, the slot 314 and the lift base connection 312. The right end of the slot 314 as depicted is the lower limit for the lift apparatus. When the lift apparatus is lowered, the sliding scissor arm pin 316 approaches this lower limit and upon reaching the lower limit, the lift apparatus is in the collapsed position.

Additionally, the left end of the slot 314 and the hydraulic cylinder limits the maximum height the lift apparatus may be raised. When the lift apparatus is raised, the sliding scissor arm pin 316 slides in the slot 314 approaching the upper limit. As the sliding scissor arm pin 316 reaches this upper limit, the hydraulic piston 506 is also reaching its travel limit so both the sliding scissor arm pin 316 and the hydraulic piston 506 reach their limits almost simultaneously thus preventing the lift apparatus from exceeding the maximum height limit.

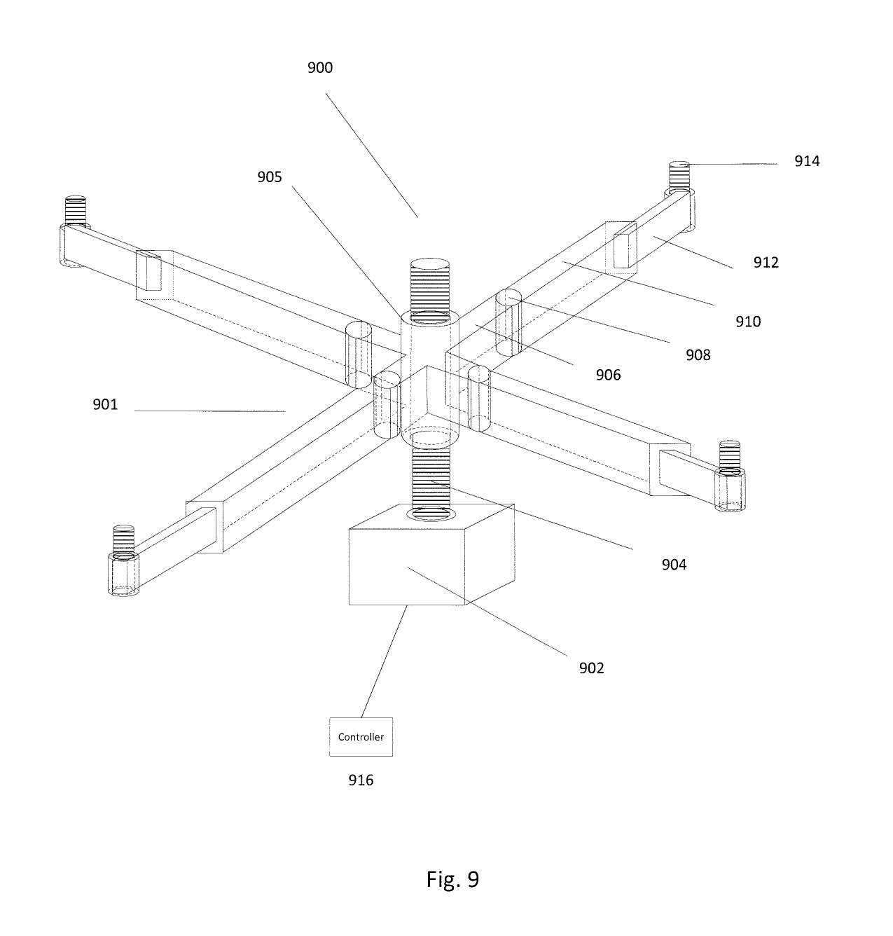

FIG. 9 shows an alternative lifting apparatus to the scissor lift 104 illustrated in the previous figures which is the preferred embodiment. This screw lift 900 has four major components, a upper support 901, a screw shaft 904, a motor 902 and a system controller 916 that when utilized together allows the user to raise and lower the chair to the desired height.

The upper support 901 has 6 major components, a center hub 905, radial arms 906, pivot points 908, adjustable radial arms 910, telescoping arms 912, and leg engagement means 914. The center hub 905 threadedly engages the screw shaft 904 as it passes through. A center hub 905 has four radial arms 906 that extend outward and each of the radial arms 906 is 90 degrees disposed from other radial arms. Radial arms 906 with proximate and distal ends wherein the proximal end is rigidly affixed to the center hub 905 and the distal end is pivotably affixed to the adjustable radial arm 910 at a pivot point 908. The pivotally adjustable radial arm 910 is slidingly affixed to the telescoping arm 912. Each of the telescoping arms 912 are affixed to the leg engagement means 914. The pivot point 908 allows engagement of different chair planforms by adjusting the angle of the arms such that once the desired angle is selected the telescoping arms 912 can be adjusted inward or outward to position the leg engagement means 914 to match the base or legs of the chair 100. Additionally, these adjustments can be used to the balance the chair 100 atop the upper support 901.

FIG. 9 further depicts the motor 902 affixed to the base of the screw shaft 904. The controller 916 provides inputs to the motor 902 directing a clockwise or counter-clockwise rotation of the screw shaft 904, whereupon the center hub moves along the shaft raising and lowering the lift apparatus according to the user's desired height.

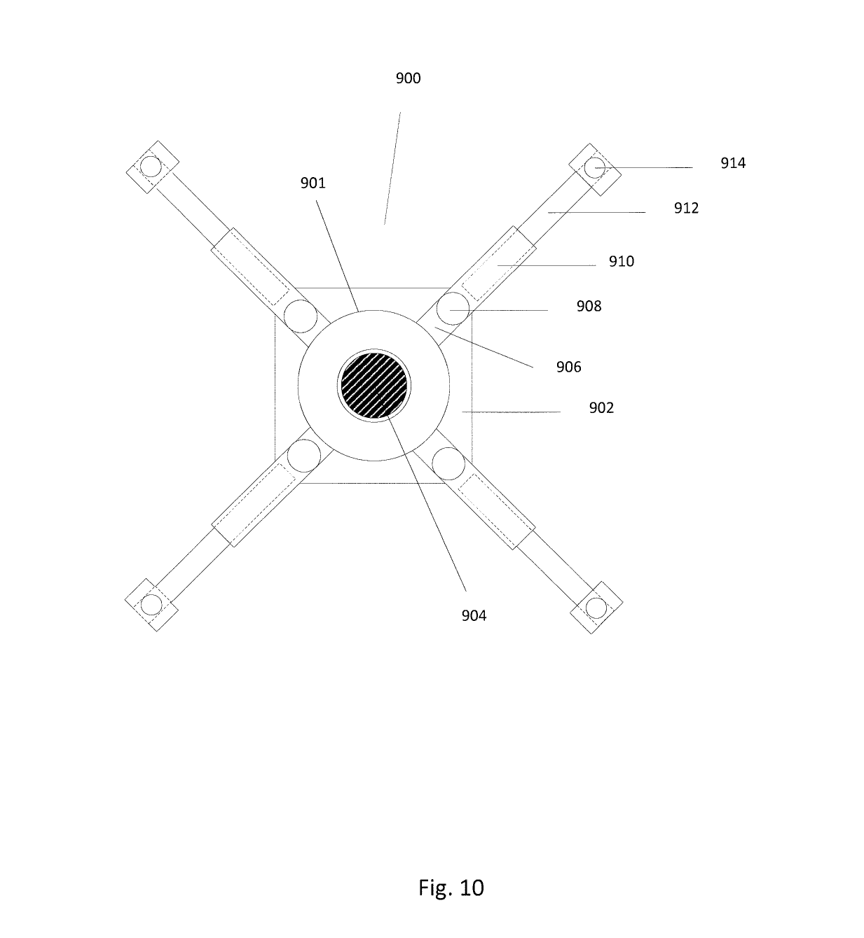

FIG. 10 depicts the top view of the screw lift apparatus with its component parts the motor 902, the screw shaft 904, and the upper support 901.

The purpose of the abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

While the invention has been shown, illustrated, described and disclosed in terms of specific embodiments or modifications, the scope of the invention should not be deemed to be limited by the precise embodiments or modifications therein shown, illustrated, described or disclosed. Such other embodiments or modifications are intended to be reserved especially as they fall within the scope of the claims herein appended.

Having thus described the invention, I claim:

1. An adjustable chair lift apparatus comprising:
a. an upper support having
i. at least one leg stand adapted to securely engage at least one chair leg,
ii. an adjustment means for moving each leg support stand to a desired location to engage each chair leg;
b. a lift means for reversibly biasing the upper support upwardly;
c. a base adapted to rest on a floor and support the apparatus; and
d. a controller in communication the lift means allowing a user to raise or lower the chair,
whereby the adjustable lift apparatus provides a simple chair lift that can easily be adapted to engage a wide range of chair types and sizes.

2. The apparatus of claim 1 where the upper support has more than one fixed position corresponding to specific chair leg configurations.

3. The apparatus of claim 1 where the upper support comprises at least one leg stand adapted to receive and secure a leg, the leg selected from a group of a foot, frame, leg, and caster.

4. The apparatus of claim 1 where the lifting means comprises at least one lifting mechanism adapted to raise and lower the adjustable lift apparatus, the lifting mechanism selected from a group of scissor, screw, hydraulic, or pneumatic lift mechanisms.

5. The apparatus of claim 4 where the lifting means further comprises a lifting mechanism control device adapted operate the lifting mechanism to raise and lower the adjustable lift apparatus, mechanism motive force selected from a group of electromechanical or electrohydraulic or electro-pneumatic devices.

6. The apparatus of claim 1, the base having at least one adjustable foot adapted to compensate for uneven surfaces.

7. The apparatus of claim 1 where the controller comprises at least one control device adapted to communicate with the lift means to manually raise and lower the lift apparatus to a desired height, the control device selected from a group of wired or wireless devices.

8. The apparatus of claim 7 where the controller further comprises at least one control device adapted to communicate with the lift means to automatically raise and lower the lift apparatus to a preprogrammed height by a single command.

9. An adjustable chair lift apparatus comprising:
a. an upper support having
i. at least one leg stand adapted to securely engage at least one chair leg,
ii. at least one longitudinal variable-length arm emanating from an body and least one lateral variable-length arm emanating from at least one longitudinal arm and adapted to adjustably engage each chair leg;
b. a lift means for reversibly biasing the upper support upwardly;
c. the base adapted to rest on the floor and support the scissor lift; and
d. a controller in communication with the lift means, allowing a user to raise or lower the chair,
whereby the adjustable lift apparatus provides a simple chair lift that can easily be adapted to engage a wide range of chair types and sizes.

10. The apparatus of claim 9, the upper support having more than one fixed position corresponding to specific chair leg configurations.

11. The apparatus of claim 9 where the upper support comprises at least one leg stand adapted to receive and secure a leg, a leg selected from a group of a foot, frame, leg, and caster.

12. The apparatus of claim 9 where the lifting means comprises at least one lifting mechanism adapted to raise and lower the adjustable lift apparatus, the lifting mechanism selected from a group of scissor, screw, hydraulic, or pneumatic lift mechanisms.

13. The apparatus of claim 12 where the lifting means further comprises a lifting mechanism control device adapted operate the lifting mechanism to raise and lower the adjustable lift apparatus, mechanism motive force selected from a group of electromechanical or electrohydraulic or electro-pneumatic devices.

14. The apparatus of claim 9, the base having at least one adjustable foot adapted to compensate for uneven surfaces.

15. The apparatus of claim 9 where the controller comprises at least one control device adapted to communicate with the scissor lift to reversibly raise the lift apparatus to a desired height, the control device selected from a group of wired or wireless devices.

16. The apparatus of claim 15 where the controller further comprises at least one control device adapted to communicate with the scissor lift to move the lift apparatus to a preprogrammed height by a single command.

17. An adjustable lift apparatus for use with a chair having at least one support leg, the apparatus comprising:
a. an upper support having
i. at least one leg stand adapted to securely engage at least one leg,
ii. at least one variable-length arm radiating from a central point for adjusting each leg support stand to a desired location to engage each chair leg;
b. a lift means for reversibly biasing the upper support upwardly;
c. a base adapted to rest on the floor and support the apparatus; and
d. a controller in communication with the lift means, allowing a user to raise or lower the chair,
whereby the adjustable lift apparatus provides a simple chair lift that can easily be adapted to engage a wide range of chair types and sizes.

18. The apparatus of claim 17 where the upper support comprises at least two arms pivotably attached to the center point adapted to engage chair legs.

19. The apparatus of claim 17 where the upper support comprises at least one leg stand adapted to receive and secure a leg, a leg selected from a group of a foot, frame, leg, and caster.

20. The apparatus of claim 17 where the lifting means comprises at least one lifting mechanism adapted to raise and lower the adjustable lift apparatus, the lifting mechanism selected from a group of scissor, screw, hydraulic, or pneumatic lift mechanisms.

21. The apparatus of claim 20 where the lifting means further comprises a lifting mechanism control device adapted operate the lifting mechanism to raise and lower the adjustable lift apparatus, mechanism motive force selected from a group of electromechanical or electrohydraulic or electro-pneumatic devices.

22. The apparatus of claim 17, the base having at least one adjustable foot adapted to compensate for uneven surfaces.

23. The apparatus of claim 17 where the controller comprises at least one control device adapted to communicate with the lifting mechanism to manually raise and lower the lift apparatus to a desired height, the control device selected from a group of wired or wireless devices. The apparatus of claim 22 where the controller further comprises at least one control adapted to communicate with the lift mechanism to automatically raise and lower the lift apparatus to a preprogrammed height by a single input.
